(19) United States
(12) Patent Application Publication
(10) Pub. No.: US 2008/0199793 A1
(43) Pub. Date: Aug. 21, 2008

(54) Electrophotographic photoreceptor having excellent electrical properties and image quality and their high stabilities and electrophotographic imaging apparatus employing the same

(75) Inventor: An-kee Lim, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd

(21) Appl. No.: 12/003,200

(22) Filed: Dec. 20, 2007

(30) Foreign Application Priority Data
Feb. 16, 2007 (KR) 10-2007-0016769

(51) Int. Cl. G03C 1/72; G03G 15/00

(52) U.S. Cl. 430/57.2; 399/159; 430/78

(57) ABSTRACT

An electrophotographic photoreceptor is provided including an undercoat layer and a photosensitive layer that are sequentially formed on an electrically conductive substrate, wherein the undercoat layer includes a silane compound represented by Formula 1, a metal oxide, and a binder resin, and an electrophotographic imaging apparatus employing the electrophotographic photoreceptor.

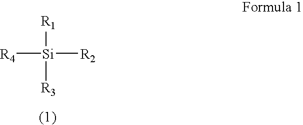

where R₁ to R are each independently a C₁-C₉ alkyl group, a C₁-C₉ alkoxy group, a phenyl group, or a phenoxy group. The electrophotographic photoreceptor has excellent electrical properties such as low residual potential and high sensitivity and excellent image quality and stability.

### CROSS-REFERENCE TO RELATED PATENT APPLICATION

This application claims the benefit of Korean Patent Application No. 10-2007-0016769, filed on Feb. 16, 2007, in the Korean Intellectual Property Office, the disclosure of which is hereby incorporated by reference in its entirety.

### BACKGROUND OF THE INVENTION

1. Field of the Invention

The present invention relates to an electrophotographic photoreceptor and an electrophotographic imaging apparatus employing the photoreceptor. More particularly, the invention relates to an electrophotographic imaging apparatus and an electrophotographic photoreceptor having excellent electrical properties and image quality and their stabilities and improved long term stability.

2. Description of the Related Art

An electrophotographic photoreceptor which is used in electrophotography applied to laser printers, photocopiers, facsimile machines, plotters, and the like, includes a photosensitive layer formed on an electrically conductive substrate and may be formed in the form of a plate, a disk, sheet, a belt, a drum, and the like. First, a surface of the photosensitive layer is uniformly and electrostatically charged, and then the charged surface is exposed to a pattern of light, thus forming the image. The light exposure selectively dissipates the charge in the exposed regions where the light strikes the surface, thereby forming a pattern of charged and uncharged regions, referred to a latent image. Then, a wet or dry toner is provided in the vicinity of the latent image, and toner droplets or particles deposit in either the charged or uncharged regions to form a toner image on the surface of the photosensitive layer. The resulting toner image can be transferred to a suitable ultimate or intermediate receiving surface, such as paper, or the photosensitive layer can function as the ultimate receptor for receiving the image.

The electrophotographic photoreceptor is classified into a negative type electrophotographic photoreceptor and a positive type electrophotographic photoreceptor. Currently, a negative type electrophotographic photoreceptor in which a negative charge is applied to the surface of a photoreceptor is widely used. However, much research on positive type electrophotographic photoreceptors in which a positive charge is applied to the surface of a photoreceptor has been actively conducted recently since a negative type electrophotographic photoreceptor has disadvantages of ozone generation and limitation on resolution improvement.

Meanwhile, photoreceptors are widely categorized into two types. The first is a laminated type photoreceptor having a laminated structure of two photosensitive layers including a charge generating layer comprising a binder resin and a charge generating material (CGM), and a charge transporting layer comprising a binder resin and a charge transporting material (mainly a hole transporting material (HTM). The laminated structure is classified into a structure in which the charge generating layer and the charge transporting layer are sequentially coated on the electrically conductive substrate, and a structure in which the charge transporting layer and the charge generating layer are sequentially coated on the electrically conductive substrate. In general, the laminated type electrophotographic photoreceptor is used in the fabrication of a negative charge type electrophotographic photoreceptor. The other type is a single layered type photoreceptor in which a binder resin, a CGM, an HTM, and an electron transporting material (ETM) are contained in a single layer. In general, the single layered type photoreceptor is used in the fabrication of a positive charge type electrophotographic photoreceptor.

The charge generating layer in the laminated type photoreceptor generates electric signals upon exposure to light and contains a CGM and a binder resin. Generally organic and inorganic photosensitive pigments are used as the CGM. Organic pigments such as azo-based pigments, perylene-based pigments, phthalocyanine-based pigments, and others, are widely used, since such organic pigments can form various compounds and crystalline structures according to synthesis methods and processing conditions, and thus, electrostatic properties of a photoreceptor can be easily modified. The binder resin disperses and facilitates such a pigment to be uniformly and strongly attached to the electrically conductive substrate. The charge transporting layer transfers electric signals generated in the charge generating layer to the surface of the photoreceptor and includes a CTM, a binder resin, and additives.

Such electrophotographic photoreceptor can also be classified into organic photoreceptors and inorganic photoreceptors. Inorganic photoreceptors using an inorganic photoconductive material, such as selenium, zinc oxide, cadmium sulfide, and others, as a main component of the photosensitive layer have been widely used. However, attempts have recently been made to use organic photoreceptors using an organic photoconductive material in the photosensitive layer, and research related thereto has been vigorously conducted. This is because inorganic photoreceptors are disadvantageous in terms of photosensitivity, durability or environment problems, whereas organic photoreceptors can have various physical properties that can be easily adjusted by changing chemical or crystalline structures of organic photoconductive materials. Also, organic photoreceptors are easy to manufacture and are inexpensive, and the range of selection for a CGM, a CTM, and a binder resin is wide, compared to inorganic photoreceptors.

Meanwhile, a metal oxide film or an undercoat layer including a binder resin can be formed between the electrically conductive substrate and the photosensitive layer. Generally, the undercoat layer is formed due to its simple and cost-effective process of manufacturing. The undercoat layer improves the adhesion of the electrically conductive substrate and the photosensitive layer, and also prevents image deterioration by suppressing the injection of charges into the photosensitive layer from the electrically conductive substrate and preventing the dielectric breakdown of the photosensitive layer. A polyamide resin is typically used as a binder resin used to form the undercoat layer, but the binder resin is not limited thereto. However, when the undercoat layer formed using the polyamide resin is too thick, residual potential may increase and image defects may occur.

A photoreceptor including an undercoat layer having a metal oxide dispersed in a polyamide resin has been reported to prevent image defects and residual potential increase. The metal oxide may be surface-treated to improve its dispersibility. However, electrical properties and stability of image quality in these photoreceptors are not satisfactory when these photoreceptors are repeatedly used. Accordingly, an electrophotographic photoreceptor having excellent electrical properties and high stability of image quality after repeated long-term use or used in an environment of high temperatures and high humidity, and more particularly, an electrophotographic photoreceptor preventing residual potential increase and photosensitivity decrease after repeated long-term use or used in an environment of high temperatures and high humidity is still needed.

To meet the requirement described above, U.S. Pat. Nos. 5,658,702; 5,932,385; 5,958,638; 5,972,550; and 6,017,664 disclose a method of increasing affinity of a metal oxide with a binder resin by adding a reactive silane coupling agent such as: a silane coupling agent including an unsaturated double bond such as allyltrimethoxysilane, allyltriethoxysilane, vinyltrimethoxy silane, vinyltriethoxy silane, vinyltrichlorosilane, allylmethyldichloro silane, and γ-methacryloxypropyltrimethoxysilane; an aminosilane coupling agent such as N-β-aminoethyl-γ-aminopropyltrimethoxysilane, N-phenyl-γ-aminopropyltriethoxysilane, and γ-aminopropyltriethoxysilane; or an epoxy silane coupling agent such as γ-glycidoxypropyltrimethoxy silane and γ-3,4-epoxycyclohexyltrimethoxysilane, to an undercoat layer. Accordingly, a uniform undercoat layer can be obtained by preventing agglomeration or gelation of the metal oxide in a coating composition for the undercoat layer. The photoreceptor including the undercoat layer can be uniformly charged by charge potential, and prevent residual potential increase, and especially prevent residual potential increase after repeated long-term use or used in an environment of high temperatures and high humidity. Thus, the photoreceptor can improve electrical properties and stability of image quality.

However, since the reactive silane coupling agent used in the conventional art described above contains a reactive bond such as a double bond, an amino group, an epoxy group, or the like, additional processes of introducing those reactive groups into silane compounds are required.

### SUMMARY OF THE INVENTION

The present invention provides an electrophotographic photoreceptor using a silane compound to provide excellent electrical properties, image quality and high stability.

The present invention also provides an electrophotographic imaging apparatus employing the electrophotographic photoreceptor.

The present invention also provides a composition that is used to form an undercoat layer having excellent dispersion and storage stabilities to easily manufacture the electrophotographic photoreceptor having excellent properties.

According to an aspect of the present invention, an electrophotographic photoreceptor is provided including an undercoat layer and a photosensitive layer that are sequentially formed on an electrically conductive substrate,
wherein the undercoat layer includes a silane compound represented by Formula 1, a metal oxide, and a binder resin.

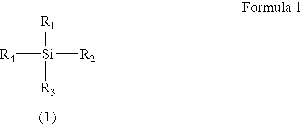

where R₁ to R₄ are each independently a C₁-C₉ alkyl group, a C₁-C₉ alkoxy group, a phenyl group, or a phenoxy group.

According to another aspect of the present invention, an electrophotographic imaging apparatus is provided including an electrophotographic photoreceptor, a charging device for charging a photosensitive layer of the electrophotographic photoreceptor, a light exposing apparatus for forming an electrostatic latent image on a surface of the photosensitive layer of the electrophotographic photoreceptor, and a developing apparatus for developing the electrostatic latent image,
wherein the electrophotographic photoreceptor includes an electrically conductive substrate, an undercoat layer and a photosensitive layer that are sequentially formed on the electrically conductive substrate, wherein the undercoat layer includes a silane compound represented by Formula 1, a metal oxide, and a binder resin.

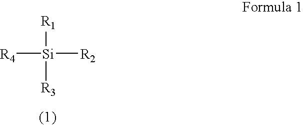

where R₁ to R₄ are each independently a C₁-C₉ alkyl group, a C₁-C₉ alkoxy group, a phenyl group, or a phenoxy group.

According to another aspect of the present invention, a coating composition is provided for an undercoat layer including:

100 parts by weight of a metal oxide particle treated with a silane compound represented by Formula 1;

20 to 1000 parts by weight of a polyamide binder resin; and

500 to 3000 parts by weight of an alcohol solvent including at least one alcohol selected from the group consisting of methanol, ethanol, isopropanol, 1-propanol, and 1-butanol.

The surface of the metal oxide particle may be treated with the silane compound.

The electrophotographic photoreceptor of the present invention has excellent electrical properties, such as low residual potentials and high sensitivities, and high image quality and stability by using a silane compound to improve dispersion of a metal oxide in an undercoat layer and combining a specific charge generating material and a charge transporting material. Here, the stability of the electrical properties refers to effectively preventing residual potential increase and photosensitivity reduction after repeated long-term use or when used in various environments such as in an environment of high temperatures and high humidity. Thus, the electrophotographic photoreceptor of the present invention can stably provide high quality image even after repeated long-term use or use in an environment of high temperatures and high humidity. According to the present invention, an uniformly coated undercoat layer in which coating defects are prevented can be obtained by inhibiting agglomeration or gelation of particles of a metal oxide in a composition for the undercoat layer.

These and other aspects of the invention will become apparent from the drawing the and detailed description of the invention which disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram schematically illustrating an electrophotographic imaging apparatus according to an embodiment of the present invention.

### DETAILED DESCRIPTION OF THE INVENTION

Hereinafter, an electrophotographic photoreceptor, and an electrophotographic imaging apparatus employing the electrophotographic photoreceptor according to embodiments of the present invention will now be described in more detail.

An electrophotographic photoreceptor according to the present invention includes an undercoat layer and a photosensitive layer that are sequentially formed on an electrically conductive substrate. The undercoat layer includes a silane compound represented by Formula 1, a metal oxide, and a binder resin.

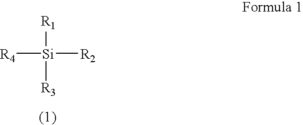

Here, R1 to R4 are each independently a C1-C9 alkyl group, a C1-C9 alkoxy group, a phenyl group, or a phenoxy group.

Examples of the electrically conductive substrate may include a metal such as aluminum, an aluminum alloy, stainless steel, copper, and nickel. Further, an insulating substrate such as polyester film, paper, glass, etc. with a conductive layer made of aluminum, copper, palladium, tin oxide, indium oxide, etc. on the surface of the insulating substrate can be used as an electrically conductive substrate. The electrically conductive substrate can be in the form of a drum, pipe, belt, plate, etc.

An undercoat layer is formed between the electrically conductive substrate and the photosensitive layer. The undercoat layer includes a silane compound represented by Formula 1, a metal oxide, and a binder resin.

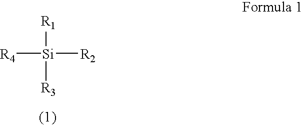

where R₁ to R₄ are each independently a C₁-C₉ alkyl group, a C₁-C₉ alkoxy group, a phenyl group, or a phenoxy group.

Examples of the metal oxide may include a tin oxide, an indium oxide, a zinc oxide, a titanium oxide, a silicon oxide, a zirconium oxide, and an aluminum oxide, which may be used alone or in combination of at least two.

An average primary diameter of the metal oxide particles may be about 150 nm or less, and preferably about 100 nm or less taking into consideration the dispersibility of the metal oxide particles.

Examples of the binder resin include a thermosetting resin that is obtained by thermally polymerizing oil-free alkyd resin, an amino resin, such as butylated melamine resin, a photocurable resin that is obtained by polymerizing a resin having an unsaturated double bond, such as unsaturated polyester or unsaturated polyurethane, a polyamide resin, a polyurethane resin, an epoxy resin, and others, which may be used alone or in combinations of at least two. The amount of the binder resin may be in the range of about 20 to 1000 parts by weight, and preferably about 50 to 200 parts by weight based on 100 parts by weight of the metal oxide. When the portion of the binder is too high, the blocking ability of the metal oxide may decrease. When the portion of the metal oxide is too high, dispersion stability may be reduced, electrical potential may not be maintained and the adhesion to the electrically conductive substrate may decrease. In one embodiment of the invention, the binder resin for the undercoat is selected from the group consisting of polyamide resin, phenol resin, melamine resin, alkyd resin, polyurethane resin, unsaturated polyester resin, epoxy resin, and mixtures thereof. In an embodiment, the coating composition for the undercoat layer includes a polyamide binder resin in an amount of about 20 to 1000 parts by weight based on 100 parts by weight of the metal oxide, and particularly a metal oxide surface treated with a silane compound of Formula 1.

The silane compound is represented by Formula 1. That is, in the silane compound, R₁ to R₄ are each independently a C₁-C₉ alkyl group, preferably a C₁-C₆ alkyl group, and more preferably a C₁-C₄ alkyl group; a C₁-C₉ alkoxy group, preferably a C₁-C₆ alkoxy group, and more preferably a C₁-C₄ alkoxy group; a phenyl group; or a phenoxy group. The undercoat layer can be less affected by moisture and uniformity and density of the coating layer can be improved since the undercoat layer becomes nonpolar due to the silane compound. Thus, the photoreceptor according to the present invention has improved electrical properties and image stability.

Examples of the silane compound may include phenyltrimethoxysilane, phenyltriethoxysilane, amyltriethoxysilane, methyltrimethoxysilane, methyltriethoxysilane, diethoxydimethylsilane, ethoxytrimethylsilane, trimethoxysilane, triethoxysilane, trimethoxypropylsilane, diethyldiethoxysilane, isobutyltrimethoxysilane, octadecyltrimethoxysilane, octyltrimethoxysilane, diethoxydimethylsilane, dimethyldimethoxysilane, diethyldimethoxysilane, dimethylphenylethoxysilane, diphenyldiethoxysilane, dimethoxydiphenylsilane, diphenylmethylethoxysilane, cyclohexyldimethoxymethylsilane, ethyltrimethoxysilane, phenyltrimethoxysilane, isobutyltriethoxysilane, methyltrimethoxysilane, octyltriethoxysilane, ethyltriethoxysilane, dodecyltriethoxysilane, diethoxymethylphenylsilane, and diethoxymethyloctadecylsilane, which may be used alone or in combination of at least two.

The amount of the silane compound may be in the range of about 0.01 to 30 parts by weight, and preferably about 1 to 10 parts by weight based on 100 parts by weight of the metal oxide. When the amount of the silane compound is less than 0.01 parts by weight, the dispersion stability, electrical properties and image stability cannot be improved. On the other hand, when the amount of the silane compound is greater than 30 parts by weight, compatibility with a binder resin may decrease, thus dispersion stability may decrease.

The surface of the metal oxide may be treated with the silane compound. For this, a metal oxide and a silane compound are added to an alcohol solvent, preferably an alcohol solvent including the same alkyl group as the alkyl or alkoxy group of the silane compound, and alumina balls and/or zirconia balls, and the like, are added thereto to treat the surface of the metal oxide and disperse the metal oxide by ball-milling for 10 to 30 hours. The resulting surface-treated metal oxide dispersion is added to a binder such as a nylon binder solution. In other embodiments, other binder resins can be used as discussed hereinafter. The mixture is treated using ultrasonic waves, and the concentration of the mixture is controlled using the alcohol to prepare a composition for an undercoat layer. A dispersion apparatus that will be described later in a preparation of a composition for a photosensitive layer can be used for preparing the dispersion.

In one embodiment, the coating composition for forming the undercoat layer comprises metal oxide particles that have been surface-treated with a silane compound of Formula 1 and a binder resin dispersed in an alcohol solvent. An example of particularly suitable binder resin is a polyamide binder resin. The alcohol solvent in this embodiment is selected from the group consisting of methanol, ethanol, isopropanol, 1-propanol, 1-butanol, and mixtures thereof. The coating composition can comprise about 100 parts by weight of a metal oxide that has been surface treated with a silane of formula 1, about 20 to 1000 parts by weight of a polyamide binder resin, and about 500 to 3000 parts by weight of an alcohol selected from the group consisting of methanol, ethanol, isopropanol, 1-propanol, 1-butanol, and mixtures thereof.

The composition for the undercoat layer is coated on an electrically conductive substrate, such as an aluminum drum and dried to prepare an undercoat layer. In one embodiment, a metal oxide layer is formed by known processes between the electrically conductive substrate and the undercoat layer.

The thickness of the undercoat layer may be in the range of about 0.1 to 20 μm, typically 0.2 to 20 μm, and preferably about 0.3 to 10 μm. When the thickness of the undercoat layer is less than 0.1 μm, the undercoat layer may be damaged by a high voltage and thus may be perforated and lead to black spots in an image or may not be uniformly formed. When the thickness of the undercoat layer is greater than 20 μm, electrostatic properties of the undercoat layer may not be controlled and the image quality may degrade.

A photosensitive layer is formed on the undercoat layer. The photosensitive layer may be a laminated type including a charge generating layer having a charge generating material and a charge transporting layer having a charge transporting material or a single layered type including a charge generating material and a charge transporting material in a single layer.

First, an electrophotographic photoreceptor using the laminated type photosensitive layer will be described. The charge generating layer formed on the undercoat layer includes a binder resin and a charge generating material dispersed or dissolved in the binder resin. Examples of the charge generating material may include organic pigments or dyestuffs, such as a phthalocyanine-based compound, a perylene-based compound, a perinone-based compound, an indigo-based compound, a quinacridone-based compound, an azo-based compound, a bisazo-based compound, a trisazo-based compound, a bisbenzoimidazole-based compound, polycycloquinone, a pyrrolopyrrol compound, a metal-free naphthalocyanine-based compound, a metal naphthalocyanine-based compound, a squalene-based compound, a squarylium-based compound, an azulenium-based compound, a quinone-based compound, a cyanine-based compound, a pyryllium-based compound, an anthraquinone-based compound, a triphenylmethane-based compound, a threne-based compound, a toluidine-based compound, a pyazoline-based compound, a quinacridone-based compound, and a mixture of at least two of these materials. A metal-free phthalocyanine-based pigment represented by Formula 2 below, a metal phthalocyanine-based pigment represented by Formula 3 below, or a mixture of these pigments may be used.

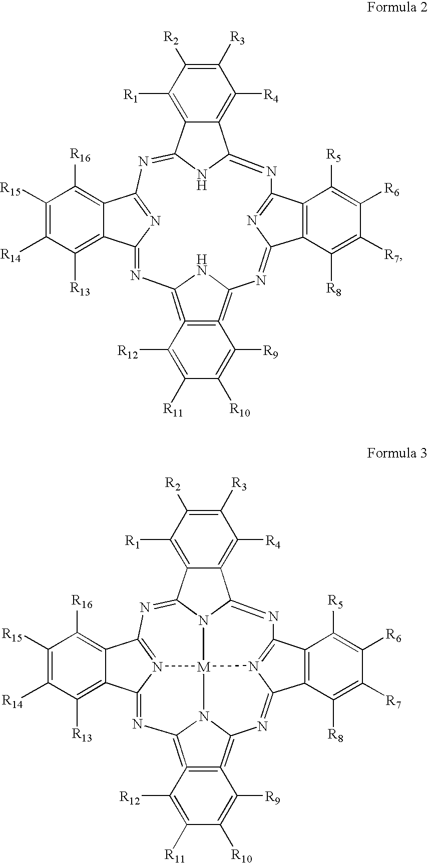

Formula 2 and Formula 3, R₁ to R₁₆ are each independently a hydrogen atom, a halogen atom, a nitro group, an alkyl group and an alkoxy group, and M is one of copper, chloroaluminum, chloroindium, cholorogallium, chlorogermanium, oxyvanadyl, oxytitanyl, hydroxygermanium or hydroxygallium.

The crystal structures of the phthalocyanine pigments of Formulae 2 and 3 used in the present invention are not limited. However, in consideration of an improvement in photosensitivity and dispersion stability, the metal-free phthalocyanine pigment may have an X-type or tau(τ)-type crystal structure, and the metal phthalocyanine pigment may be a Y-type or α-type oxytitanyl phthalocyanine.

When a phthalocyanine-based compound is used as a charge generating material of the charge generating layer, a different charge generating material as described above can be used together for the adjustment of spectral sensitivity. Also, an electron accepting material may be further included for sensitivity improvement, residual potential reduction and/or reduction in fatigue accumulated due to repeated use. Examples of the electron accepting material with high electron affinity may include succinic anhydride, maleic anhydride, dibromosuccinic anhydride, phthalic anhydride, 3-nitro phthalic anhydride, 4-nitro phthalic anhydride, pyromellitic anhydride, pyromellitic acid, trimellitic acid, trimellitic anhydride, phthalimide, 4-nitrophthalimide, tetracyanoethylene, tetracyano quinodimethane, chloranyl, bromanil, o-nitro benzoic acid, and p-nitro benzoic acid. The amount of the electron accepting material may be in the range of about 0.01 to 100% by weight based on the weight of the charge generating material.

The thickness of the charge generating layer may be in the range of about 0.01 to 10 μm, and preferably about 0.05 to 3 μm. When the thickness of the charge generating layer is less than 0.01 μm, the charge generating layer may not be uniformly formed and the sensitivity and the mechanical durability may not be sufficient. When the thickness of the charge generating layer is greater than 10 μm, electrophotographic properties may degrade.

The amount of the charge generating material and the amount of the binder resin in the charge generating layer are not limited and can be determined within an allowable range known in the art. For example, the ratio of the charge generating material to the binder resin in the charge generating layer may be about 1:0.1 to 1:5. When the amount of the charge generating material is too small, the amount of generated charges is not sufficient, and thus the photosensitivity is not sufficient and the residual potential may increase. When the amount of the charge generating material is too large, the amount of the resin in the photosensitive layer becomes relatively small, and thus the mechanical strength and the dispersion stability of the charge generating material may be reduced. When the charge generating material has a film-forming ability, the binder resin may not be needed.

The charge generating layer may be formed using a deposition, sputtering, and the like, as well as dip coating, roll coating, spin coating and so forth.

A charge transporting layer is formed on the charge generating layer. The charge transporting layer includes a binder resin, a heat stabilizer, and a charge transporting material dispersed or dissolved in the binder resin. Examples of the charge transporting material include a hole transporting material and an electron transporting material. When the laminated type photoreceptor is a negative charge type, a hole transporting material is used as a main component of the charge transporting layer. When the laminated type photoreceptor is a positive charge type, an electron transporting material is used as a main component of the charge transporting layer. When the laminated type photoreceptor needs to have bipolarity, i.e., photoreceptor is sometimes positively charged and sometimes negatively charged depending on the needs, a combination of a hole transporting material and an electron transporting material can be used. When the charge transporting material has a film-forming ability, the binder resin may not be needed. However, a low-molecular weight charge transporting material that cannot form a film need the binder resin.

The thickness of the charge transporting layer may be in the range of about 2 to 100 μm, preferably about 5 to 50 μm, and more preferably about 10 to 40 μm. When the thickness of the charge transporting layer is less than 2 μm, the charging properties may degrade. When the thickness of the charge transporting layer is greater than 100 μm, the response rate and the quality of a printed image may degrade. The amounts of the binder resin and the charge transporting material in the charge transporting layer in the present invention are not limited, and can be determined within an allowable range known in the art. For example, the amount of the charge transporting material may be in the range of about 10 to 200 parts by weight, and preferably about 20 to 150 parts by weight, based on 100 parts by weight of the binder resin. When the amount of the charge transporting material is less than 10 parts by weight, the charge transporting capability is insufficient, and thus the sensitivity is insufficient and the residual potential may increase. When the amount of the charge transporting material is greater than 200 parts by weight, the mechanical strength may be reduced.

The charge transporting material dispersed or dissolved in the binder resin in the charge transporting layer may be a hole transporting material and/or an electron transporting material. Examples of low-molecular weight compounds that can be used as the hole transporting material may include a pyrene-based compound, a carbazole-based compound, a hydrazone-based compound, an oxazole-based compound, an oxadiazole-based compound, a pyrazoline-based compound, an arylamine-based compound, an arylmethane-based compound, a benzidine-based compound, a thiazole-based compound, a styryl-based compound, a stilbene-based compound, a butadiene-based compound, and a butadiene-based amine compound. Examples of polymer compounds that can be used as the hole transporting material may include polyarylalkane, polyvinyl carbazole, halogenated polyvinyl carbazole, polyvinylpyrene, polyvinyl anthracene, polyvinyl acridine, a formaldehyde-based condensation resin, such as, a pyrene-formaldehyde resin and an ethylcarbazole-formaldehyde resin, a triphenylmethane polymer, polysilane, an N-acrylamide methylcarbazole polymer, a styrene copolymer, polyacenaphthylene, polyindene, and a copolymer of acenaphthylene and styrene. Examples of the electron transporting material may include electron absorbing low-molecular weight compounds, such as a benzoquinone-based compound, a naphthoquinone-based compound, an anthraquinone-based compound, a malononitrile-based compound, a fluorenone-based compound, a dicyanofluorenone-based compound, a benzoquinoneimine-based compound, a diphenoquinone-based compound, a stilbene quinine-based compound, a diiminoquinone-based compound, a dioxotetracenedione-based compound, a thiopyran-based compound, a tetracyanoethylene-based compound, a tetracyanoquinodimethane-based compound, a xanthone-based compound, a phenanthraquinone-based compound, a phthalic anhydride-based compound, a naphthalene-based compound, etc. However, examples of the electron transporting material are not limited to the above. Polymer compounds or pigments that can transport electrons also can be used. The above-described charge transporting materials may be used alone or in combinations of at least two in the electrophotographic photoreceptor according to the present invention. For example, use of a combination of a butadiene-based amine compound and a hydrazone-based compound, or a benzidine-based compound as the charge transporting material can be more effective to suppress image deterioration caused by repeated use of the photoreceptor. Accordingly, the charge transporting material may be a combination of a butadiene-based amine compound and a hydrazone-based compound, or a benzidine-based compound. In addition to the above-described hole transporting materials and electron transporting materials, any material having a charge mobility of 10⁻⁸ cm²/s or greater may be used.

The charge transporting layer may include a heat stabilizer. Examples of the heat stabilizer used in the charge transporting layer may include a phenol-based heat stabilizer, a phosphite-based heat stabilizer, a thioether-based heat stabilizer, etc. In the charge transporting layer, the amount of the heat stabilizer may be in the range of about 0.01 to 15% by weight, and preferably about 0.01 to 10% by weight based on the weight of the charge transporting material. When the amount of the heat stabilizer is less than 0.01% by weight, effects of using the heat stabilizer such as preventing image quality deterioration caused by repeated use cannot be obtained. When the amount of the heat stabilizer is greater than 15% by weight, durability may degrade since layers are worn and adhesion between layers is reduced.

Examples of the phenol-based heat stabilizer may include 2,6-di-tert-butylphenol, 2,6-di-tert-butyl-4-methoxyphenol, 2,6-di-tert-butyl-4-methyl phenol, 2-tert-butyl-4-methoxyphenol, 2,4-dimethyl-6-tert-butylphenol, 2-tert-butylphenol, 3,6-di-tert-butylphenol, 2,4-di-tert-butylphenol, 2,6-di-tert-butyl-4-ethylphenol, 2-tert-butyl-4,6-methyl phenol, 2,4,6-tert-butylphenol, 2,6-di-tert-butyl-4-stearyl propionate phenol, α-tocopherol, β-tocopherol, γ-tocopherol, naphtol AS, naphtol AS-D, naphtol AS-BO, 4,4′-methylenebis(2,6-di-tert-butylphenol), 4,4′-methylenebis(6-tert-butyl-4-methyl phenol), 2,2′-methylenebis(4-methyl-6-tert-butylphenol), 2,2′-methylenebis(4-ethyl-6-tert-butylphenol), 2,2′-ethylenebis(4,6-di-tert-butylphenol), 2,2′-propylenebis(4,6-di-tert-butylphenol), 2,2′-butanebis(4,6-di-tert-butylphenol), 2,2′-ethylenebis(6-tert-butyl-m-cresol), 4,4′-butanebis(6-tert-butyl-m-cresol), 2,2′-butanebis(6-tert-butyl-p-cresol), 2,2′-thiobis(6-tert-butylphenol), 4,4′-thiobis(6-tert-butyl-m-cresol), 4,4′-thiobis(6-tert-o-cresol), 2,2′-thiobis(4-methyl-6-tert-butylphenol), 1,3,5-trimethyl-2,4,6-tris(3,5-di-tert-butyl-4-hydroxybenzyl)benzene, 1,3,5-trimethyl-2,4,6-tris(3,5-di-tert-amyl-4-hydroxybenzyl)benzene, 1,3,5-trimethyl-2,4,6-tris(3-tert-butyl-5-methyl-4-hydroxybenzyl)benzene, 2-tert-butyl-5-methyl-phenyl amine phenol, 4,4′-bis amino(2-tert-butyl-4-methyl phenol), n-octadecyl-3-(3′,5′-di-tert-butyl-4′-hydroxyphenyl)propionate, 2,2,4-trimethyl-6-hydroxy-7-tert-butyl chroman, tetrakis(methylene-3(3,5-di-tert-butyl-4-hydroxyphenyl)propionate)methane, 1,1,3-tris(2-methyl-4-hydroxy-5-tert-butylphenyl)butane, and the like, but are not limited thereto.

Examples of the phosphite-based heat stabilizer may include trimethyl phosphite, triethyl phosphite, tri-n-butyl phosphite, trioctyl phosphite, tridecyl phosphite, tridodecyl phosphite, tristearyl phosphite, trioleyl phosphite, tristridecyl phosphite, tricetyl phosphite, dilaurylhydrodiene phosphite, diphenylmonodecyl phosphite, diphenylmono(tridecyl) phosphite, tetraphenyldipropylene glycol phosphite, 4,4′-butylidene-bis(3-methyl-6-t-phenyl-di-tridecyl)phosphite, distearyl pentaerythritol disphosphite, ditridecyl pentaerythritol disphosphite, dinonylphenyl pentaerythritol disphosphite, diphenyloctyl phosphite, tetra(tridecyl)-4,4′-isopropylidenediphenyl diphosphite, tris(2,4-di-t-butylphenyl)phosphite, tris(2,4-di-t-amylphenyl)phosphite, tris(2-tert-butyl-4-methylphenyl)phosphite, tris(2-ethyl-4-methylphenyl)phosphite, tris(4-nonylphenyl)phosphite, di(2,4-di-t-butylphenyl)pentaerythritol disphosphite, di(nonylphenyl)pentaerythritol disphosphite, tris(nonylphenyl)phosphite, tris(p-tert-octylphenyl)phosphite, tris(p-2-butenylphenyl)phosphite, bis(p-nonylphenyl)cyclohexyl phosphite, tetrakis(2,4-di-tert-butylphenyl)-4,4′-biphenylene diphosphite, 2,6-di-tert-butyl-4-methyl phenyl phenyl pentaerythritol disphosphite, 2,6-di-tert-butyl-4-ethylphenyl stearyl pentaerythritol disphosphite, di(2,6-di-tert-butyl-4-methyl phenyl)pentaerythritol disphosphite, 2,6-di-tert-amyl-4-methylphenyl phenylpentaerythritol disphosphite, and the like, but are not limited thereto.

Examples of the thioether-based heat stabilizer may include dilauryl thiodipropionate, dimyristyl thiodipropyonate, laurylstearyl thiodipropionate, distearyl thiodipropionate, dimethyl thiodipropionate, 2-mercaptobenzimidazole, phenothiazine, octadecyl thioglycolate, butyl thioglycolate, octyl thioglycolate, a thiocresol, and the like, but are not limited thereto.

The binder resin that can be used in the undercoat layer, the charge generating layer, and the charge transporting layer of the electrophotographic photoreceptor according to the present invention may be any insulating resin having a film-forming ability. Examples of the binder resin may include polycarbonate, polyarylate (such as a condensed polymer of bisphenol A and phthalic acid), polyamide, polyester, an acrylic resin, a methacrylic resin, polyvinyl chloride, polyvinylidene chloride, polystyrene, polyvinyl acetate, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone-alkyd resin, a phenol-formaldehyde resin, a styrene-alkyd resin, a polyvinyl acetal, such as polyvinyl butyral and polyvinyl formal, polysulfone, casein, gelatin, polyvinyl alcohol, polyamide, a cellulose-based resin, such as ethyl cellulose and carboxymethyl cellulose, polyurethane, a polyacrylamide resin, polyvinyl pyridine, an epoxy resin, polyketone, polyacrylonitrile, a melamine resin, polyvinyl pyrrolidone, and the like, but are not limited thereto. These binder resins may be used alone or in combinations of at least two. Organic photoconductive resins, such as poly N-vinylcarbazole, polyvinyl anthracene, polyvinylpyrene, and the like, also may be used.

The binder resin of the charge transporting layer as a surface layer of the photosensitive layer may be a polycarbonate resin, and in particular, polycarbonate-Z derived from cyclohexylidene bisphenol, rather than polycarbonate-A derived from bisphenol A or polycarbonate-C derived from methylbisphenol A, since the polycarbonate-Z derivative has a high glass transition temperature and high wear resistance.

Solvents for the coating compositions used to form the undercoat layer, the charge generating layer, and the charge transporting layer of the electrophotographic photoreceptor according to the present invention vary according to the type of the used resin and may be selected not to adversely affect on an adjacent layer during coating. Examples of such solvents may include: aromatic hydrocarbons such as benzene, xylene, ligroin, monochlorobenzene, and dichlorobenzene; ketones such as acetone, methylethyl ketone, and cyclohexanone; alcohols such as methanol, ethanol, and isopropanol; esters such as ethyl acetate, and methyl cellosolve; halogenated aliphatic hydrocarbons such as carbon tetrachloride, chloroform, dichloromethane, dichloroethane, and trichloroethylene; ethers such as tetrahydrofurane, dioxane, dioxolane, and ethylene glycol monomethyl ether; amides such as N,N-dimethylformamide, and N,N-dimethyl acetamide; and sulfoxides such as dimethyl sulfoxide. These solvents may be used alone or in combinations of at least two.

The charge generating layer and the charge transporting layer of the electrophotographic photoreceptor according to the present invention can be obtained by coating a homogeneous coating composition containing such a component in an amount as described above on an electrically conductive substrate and drying the coated composition. A dispersion apparatus that is commonly known in the field of paint and ink may be used to obtain the homogeneous coating composition. For example, an attritor, a paint shaker, a ball-mill, a sand-mill, a high-speed mixer, a Banbury mixer, a spec mixer, a roll-mill, a three-roll mill, a nanomizer, a microfluidizer, a stamp mill, a planetary mill, a vibration mill, a kneader, or the like can be used. Glass beads, steel beads, zirconium oxide beads, alumina balls, zirconium oxide balls, flint stone, or the like may be used in the dispersion apparatus. Homogeneous coating solutions obtained using such a dispersion apparatus are coated on an electrically conductive substrate using a conventional coating apparatus, such as a dip-coater, a spray coater, a wire-bar coater, an applicator, a doctor blade, a roller coater, a curtain coater, or a bead coater to predetermined thicknesses and dried to complete an electrophotographic photoreceptor of the present invention.

Meanwhile, the photosensitive layer according to the present invention may be a single layered type including a charge generating material and a charge transporting material in a single layer. In the single layered type, the photosensitive layer is formed by coating a mixture of the charge generating material, the binder resin, and the charge transporting material dispersed in a solvent. Generally, the thickness of the single layered photosensitive layer is in the range of about 5 to 50 μm.

The undercoat layer and/or the photosensitive layer may further include additives such as a plasticizer, a surface modifier and antioxidant.

Examples of the plasticizer may include biphenyl, chlorinated biphenyl, terphenyl, dibutyl phthalate, diethylene glycol phthalate, dioctyl phthalate, triphenyl phosphoric acid, methylnaphthalene, benzophenone, chlorinated paraffin, polypropylene, polystyrene, and various fluorinated hydrocarbons, but are not limited thereto.

Examples of the surface modifier may include silicone oil, and fluorine resin.

Examples of the antioxidant may include a hindered phenol-based compound, an aromatic amine-based compound, and a quinone-based compound.

Meanwhile, the electrophotographic photoreceptor according to the present invention may further include a metal oxide film such as an anodic oxide film formed using a sulfuric acid solution, an oxalic acid, and the like, between the electrically conductive substrate and the undercoat layer. The anodic oxide film may include an alumite film.

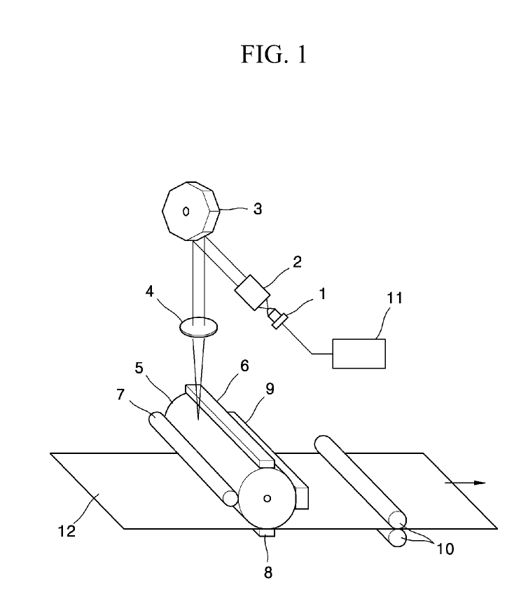

FIG. 1 is a schematic view of an electrophotographic image forming apparatus according to an embodiment of the present invention. Referring to FIG. 1, reference numeral 1 indicates a semiconductor laser. Laser light that is signal-modulated by a control circuit 11 according to image information is collimated by an optical correction system 2 after radiated and performs scanning while being reflected by a polygonal rotatory mirror 3. The laser light is focused on a surface of an electrophotographic photoreceptor 5 by a scanning lens 4 to expose a region of the surface according to the image information. The electrophotographic photoreceptor is previously charged by a charging apparatus 6, and thus an electrostatic latent image is formed on the surface through the exposure process and then turned into a toned image by a developing apparatus 7. The toned image is transferred to an image receptor 12, such as paper, by a transferring apparatus 8, and fixed as a print result by a fixing apparatus 10. The electrophotographic photoreceptor can be repeatedly used by removing a coloring agent remaining on the surface thereof using a cleaning apparatus 9. Although the electrophotographic photoreceptor in FIG. 1 is a drum type, an electrophotographic photoreceptor according to the present invention can be formed as a sheet or a belt.

Hereinafter, the present invention will be described in more detail with reference to the following examples. However, these examples are given for the purpose of illustration and are not intended to limit the scope of the invention.

### EXAMPLE 1

4000 parts by weight of alumina balls (5 mmΦ), 160 parts by weight of titanium oxide (TTO-55N manufactured by Ishihara Industries, Co., an average primary diameter of about 35 nm), and 4 parts by weight of dimethyldimethoxysilane were added to 320 parts by weight of methanol, and dispersed by ball-milling for 20 hours. The obtained dispersion was diluted with 1,120 parts by weight of the methanol, and the diluted dispersion was added to a solution having 80 parts by weight of Nylon resin (CM 8000 manufactured by Toray Industries, Co.) dissolved in 320 parts by weight of methanol, and homogenized to prepared a coating composition for an undercoat layer. The coating composition for an undercoat layer was coated on an aluminum drum having an outer diameter of 24 mmΦ, a length of 236 mm, and a thickness of 1 mm and dried in an oven at 100° C. for 30 minutes to form the undercoat layer having a thickness in the range of 1 to 5 μm.

5 parts by weight of γ-type oxytitanyl phthalocyanine, 2.5 parts by weight of polyvinyl butyral resin (6000C manufactured by Denki Kagaku Kogyo K.K.), and 80 parts by weight of tetrahydrofurane (THF) were dispersed together with alkali glass beads having a diameter of 1 to 1.5 mm using a paint shaker for 30 minutes, and ball-milled for 30 minutes, and this process was repeated 4 times. Then, 272 parts by weight of THF was added to the dispersion and the glass beads were removed to prepare a coating composition for a charge generating layer. The coating composition was coated on the undercoat layer and dried in an oven at 120° C. for 30 minutes to form the charge generating layer having a thickness of 0.2 to 0.5 μm.

4.2 parts by weight of 4-dibenzylamino-2-methylbenzaldehyde diphenylhydrazone (CTC191 manufactured by Takasago International Corporation), 4.2 parts by weight of 1,1-bis-(p-diethylaminophenyl)-4,4-diphenyl-1,3-butadiene (T405 manufactured by Takasago International Corporation), 10.5 parts by weight of polycarbonate resin (TS-2050 manufactured by Teijin Ltd.), 0.42 parts by weight of 2,6-di-tert-butyl-4-methyl phenol as a heat stabilizer, and 0.004 parts by weight of silicone oil (KF-50 manufactured by Shinetsu Chemical Co., Ltd.) were dissolved in a mixed solvent of 70 parts by weight of THF and 8.6 parts of toluene to prepare a coating composition for a charge transporting layer. The coating composition was coated on the charge generating layer and dried in an oven at 120° C. for 30 minutes to form the charge transporting layer having a thickness of 15 to 35 μm to form a negative charge type laminated photoreceptor drum.

### EXAMPLE 2

A laminated type photoreceptor drum was prepared in the same manner as in Example 1, except that 4 parts by weight of phenyltrimethoxysilane was used instead of 4 parts by weight of dimethyldimethoxysilane to prepare a coating composition for the undercoat layer.

### EXAMPLE 3

A laminated type photoreceptor drum was prepared in the same manner as in Example 1, except that 4 parts by weight of trimethoxypropylsilane was used instead of 4 parts by weight of dimethyldimethoxysilane to prepare a coating composition for the undercoat layer.

### EXAMPLE 4

A laminated type photoreceptor drum was prepared in the same manner as in Example 1, except that 4 parts by weight of ethyltrimethoxysilane was used instead of 4 parts by weight of dimethyldimethoxysilane to prepare a coating composition for the undercoat layer.

### EXAMPLE 5

A laminated type photoreceptor drum was prepared in the same manner as in Example 1, except that 4 parts by weight of methyltrimethoxysilane was used instead of 4 parts by weight of dimethyldimethoxysilane to prepare a coating composition for the undercoat layer.

### EXAMPLE 6

A laminated type photoreceptor drum was prepared in the same manner as in Example 1, except that 4 parts by weight of isobutyltrimethoxysilane was used instead of 4 parts by weight of dimethyldimethoxysilane to prepare a coating composition for the undercoat layer.

### EXAMPLE 7

A laminated type photoreceptor drum was prepared in the same manner as in Example 1, except that 8 parts by weight of dimethyldimethoxysilane was used to prepare a coating composition for the undercoat layer.

### EXAMPLE 8

A laminated type photoreceptor drum was prepared in the same manner as in Example 1, except that 5 parts by weight of α-type oxytitanyl phthalocyanine was used instead of 5 parts by weight of γ-type oxytitanyl phthalocyanine to prepare a coating composition for the charge generating layer.

### EXAMPLE 9

A laminated type photoreceptor drum was prepared in the same manner as in Example 1, except that 4 parts by weight of trimethoxypropylsilane was used instead of 4 parts by weight of dimethyldimethoxysilane to prepare a coating composition for the undercoat layer, and 5 parts by weight of α-type oxytitanyl phthalocyanine was used instead of 5 parts by weight of γ-type oxytitanyl phthalocyanine to prepare a coating composition for the charge generating layer.

### EXAMPLE 10

A laminated type photoreceptor drum was prepared in the same manner as in Example 1, except that 4 parts by weight of methyltrimethoxysilane was used instead of 4 parts by weight of dimethyldimethoxysilane to prepare a coating composition for the undercoat layer, and 5 parts by weight of α-type oxytitanyl phthalocyanine was used instead of 5 parts by weight of γ-type oxytitanyl phthalocyanine to prepare a coating composition for the charge generating layer.

### EXAMPLE 11

A laminated type photoreceptor drum was prepared in the same manner as in Example 1, except that 4.2 parts by weight of N,N′-bis(3-methylphenyl)-N,N′-bis(phenyl)benzidine and 4.2 parts by weight of N,N,N′,N′-tetrakis(4-methylphenyl)benzidine were used instead of 4.2 parts by weight of 4-dibenzylamino-2-methylbenzaldehyde diphenylhydrazone (CTC191 manufactured by Takasago International Corporation) and 4.2 parts by weight of 1,1-bis-(p-diethylaminophenyl)-4,4-diphenyl-1,3-butadiene (T405 manufactured by Takasago International Corporation) to prepare a coating composition for the charge transporting layer.

### EXAMPLE 12

A laminated type photoreceptor drum was prepared in the same manner as in Example 1, except that 5 parts by weight of α-type oxytitanyl phthalocyanine was used instead of 5 parts by weight of γ-type oxytitanyl phthalocyanine to prepare a coating composition for the charge generating layer, and 4.2 parts by weight of N,N′-bis(3-methylphenyl)-N,N′-bis(phenyl)benzidine and 4.2 parts by weight of N,N,N′,N′-tetrakis(4-methylphenyl)benzidine were used instead of 4.2 parts by weight of 4-dibenzylamino-2-methylbenzaldehyde diphenylhydrazone (CTC191 manufactured by Takasago International Corporation) and 4.2 parts by weight of 1,1-bis-(p-diethylaminophenyl)-4,4-diphenyl-1,3-butadiene (T405 manufactured by Takasago International Corporation) to prepare a coating composition for the charge transporting layer.

### EXAMPLE 13

80 parts by weight of Nylon resin (CM 8000 manufactured by Toray Industries, Co.) was dissolved in 320 parts by weight of methanol. 4000 parts by weight of alumina balls (5 mmΦ), 160 parts by weight of titanium oxide (TTO-55N manufactured by Ishihara Industries, Co., an average primary diameter of about 35 nm), and 4 parts by weight of dimethyldimethoxysilane were added to the Nylon resin solution and dispersed by ball-milling for 20 hours. The obtained dispersion was diluted with 1,120 parts by weight of methanol to prepare a coating composition for an undercoat layer. The coating composition for an undercoat layer was coated on an aluminum drum having an outer diameter of 24 mmΦ, a length of 236 mm, and a thickness of 1 mm and dried in an oven at 100° C. for 30 minutes to form the undercoat layer having a thickness of 1 to 5 μm.

0.14 parts by weight of X-type metal-free phthalocyanine, 5.1 parts by weight of 1,1-bis-(p-diethylaminophenyl)-4,4-diphenyl-1,3-butadiene, 3.1 parts by weight of 3,5-dimethyl-3′,5′-di-t-butyl 4,4′-diphenoquinone, 10.1 parts by weight of polycarbonate resin (TS-2050 manufactured by Teijin Ltd.), and 0.05 parts by weight of antioxidant Irganox® 565 (Ciba Specialty Chemical, Co.) were dissolved in a mixed solvent of 90 parts by weight of THF and 5 parts of toluene and dispersed using 800 parts by weight of zirconia beads (5 mmΦ) by ball-milling for about 48 hours, and the zirconia beads were removed to prepare a coating composition for a single layered photosensitive layer. The coating composition was coated on the undercoat layer, and dried in an oven at 120° C. for 30 minutes to form a single layered photosensitive layer having a thickness of about 20 μm to form a single layered photoreceptor drum.

### COMPARATIVE EXAMPLE 1

A laminated type photoreceptor drum was prepared in the same manner as in Example 1, except that the undercoat layer was not formed.

### COMPARATIVE EXAMPLE 2

A laminated type photoreceptor drum was prepared in the same manner as in Example 1, except that dimethyldimethoxysilane was not used to prepare a coating composition for the undercoat layer.

### COMPARATIVE EXAMPLE 3

A laminated type photoreceptor drum was prepared in the same manner as in Example 1, except that 50 parts by weight of dimethyldimethoxysilane was used to prepare a coating composition for the undercoat layer.

### COMPARATIVE EXAMPLE 4

A laminated type photoreceptor drum was prepared in the same manner as in Example 8, except that the undercoat layer was not formed.

### COMPARATIVE EXAMPLE 5

A laminated type photoreceptor drum was prepared in the same manner as in Example 8, except that dimethyldimethoxysilane was not used to prepare a coating composition for the undercoat layer.

### COMPARATIVE EXAMPLE 6

A single layered type photoreceptor drum was prepared in the same manner as in Example 13, except that dimethyldimethoxysilane was not used to prepare the undercoat layer.

Evaluation of Dispersion Stability of Coating Composition for Undercoat Layer

Dispersion stabilities of each of the coating compositions for an undercoat layer prepared according to Examples 1 to 7, and 11 and Comparative Examples 1 to 3 were evaluated right after the preparation and after 30 days at room temperature as follows.
good: precipitation of titanium oxide particles were not observed.
fair: about 5% of precipitation of titanium oxide particles were observed.
poor: about 20% of precipitation of titanium oxide particles were observed.

Evaluation of Electrical Properties

Electrophotographic properties of each of the electrophotographic photoreceptors were evaluated using an apparatus for estimating the electrostatic property of a drum photoreceptor (PDT-2000, manufactured by QEA INC.) at 23° C. and a relative humidity of 50% as follows.

Each of the photoreceptors was charged at a corona voltage of −7.5 kV (at a corona voltage of +7.5 kV in Example 13 and Comparative Example 6) and a relative speed of 100 mm/sec of a charger and the photoreceptor. Immediately after that, the photoreceptor drum was exposed to a monochromatic light having a wavelength of 780 nm and energy of 10 μJ/cm². A surface potential Vr(V) of the photoreceptor drum after 10 seconds of light exposure, a surface potential V₀(V) of the photoreceptor drum without the light exposure, and light exposure energy E_{1/2}(μJ/cm²) required to decrease V₀ to V₀/2 were measured. Here, Vr(V) is an index of residual potential, and E_{1/2}(μJ/cm²) is an index of photosensitivity.

Measurement of Image Density

The optical densities of images were measured to evaluate image density of a halftone image pattern obtained using each of the photoreceptors prepared according to Examples and Comparative Examples were measured according to a manner as follows.

That is, the optical densities (OD) of a halftone image pattern which was printed using a laser printer ML-1610 (manufactured by Samsung Electronics), in which a laminated type photoreceptor drum prepared in Examples 8 to 10 and 12 and Comparative Examples 4 and 5 was mounted at 32° C. and a relative humidity of 80% (H/H), using an optical densitometer (SpectroEye manufactured by GretagMacbeth). The results are shown in Table 2. The image densities after printing a single sheet of paper and after printing 3,000 sheets of paper were evaluated.

The results are shown in Tables 1 to 3.

TABLE 1

| | Electrical properties | | | | Stability of coating | |
|---|---|---|---|---|---|---|
| | Initial | | After 1000 | | composition for | |
| | stage | | cycles | | undercoat layer | |
| | Vr | E_{1/2} | Vr | E_{1/2} | Initial | after 30 days |
| Example 1 | −10 | 0.13 | −13 | 0.13 | good | good |
| Example 2 | −12 | 0.15 | −15 | 0.14 | good | fair |
| Example 3 | −13 | 0.16 | −15 | 0.14 | good | fair |
| Example 4 | −10 | 0.14 | −12 | 0.13 | good | good |
| Example 5 | −12 | 0.14 | −14 | 0.13 | good | good |
| Example 6 | −15 | 0.16 | −20 | 0.15 | good | fair |
| Example 7 | −12 | 0.15 | −17 | 0.16 | fair | fair |
| Example 11 | −17 | 0.16 | −25 | 0.14 | — | — |
| Comparative | −8 | 0.15 | −27 | 0.12 | — | — |
| Example 1 | | | | | | |
| Comparative | −15 | 0.14 | −24 | 0.12 | good | poor |
| Example 2 | | | | | | |
| Comparative | −17 | 0.17 | −30 | 0.22 | fair | poor |
| Example 3 | | | | | | |

Referring to Table 1, stability of coating compositions for an undercoat layer prepared according to Examples 1 to 7 and 11 of the present invention was excellent. Further, the laminated type photoreceptors prepared according to Examples 1 to 7 and 11 of the present invention had similar residual potential and photosensitivity to the laminated type photoreceptors prepared according to Comparative Examples 1 to 3 at the initial stage. However, variations in residual potential and photosensitivity of the photoreceptors of Examples 1 to 7 and 11 were suppressed after 1000 cycles compared to those of the photoreceptors of Comparative Examples 1 to 3. Accordingly, the photoreceptor of the present invention had excellent stability in electrical properties.

TABLE 2

| | | | Image property | |
|---|---|---|---|---|
| | Electrical property | | | OD (after printing |
| | Vr | E_{1/2} | OD (initial) | 3000 sheets) |
| Example 8 | −14 | 0.33 | 0.18 | 0.32 |
| Example 9 | −15 | 0.34 | 0.17 | 0.33 |
| Example 10 | −10 | 0.33 | 0.18 | 0.30 |
| Example 12 | −19 | 0.30 | 0.19 | 0.38 |
| Comparative | −13 | 0.34 | 0.20 | 0.50 |
| Example 4 | | | | |
| Comparative | −14 | 0.33 | 0.19 | 0.42 |
| Example 5 | | | | |

Referring to Table 2, the laminated type photoreceptors prepared according to Examples 8 to 10 and 12 of the present invention had similar residual potential and photosensitivity to the laminated type photoreceptors prepared according to Comparative Examples 4 to 5 at the initial stage. However, optical density increasing rate of the photoreceptors of Examples 8 to 10 and 12 were suppressed after printing 3000 sheets of paper compared to those of the photoreceptors of Comparative Examples 4 to 5. Thus, the laminated type photoreceptor of the present invention had excellent stability in image quality.

TABLE 3

| | |
|---|---|
| Electrical property | Image property |
| initial | after 1000 cycles |

| | Vr | E_{1/2} | Vr | E_{1/2} |
|---|---|---|---|---|
| Example 13 | 34 | 0.30 | 40 | 0.31 |
| Comparative | 40 | 0.32 | 51 | 0.28 |
| Example 6 | | | | |

Referring to Table 3, the single layered photoreceptor prepared according to Example 13 of the present invention had similar residual potential and photosensitivity to the single layered photoreceptor prepared according to Comparative Example 6. However, variations in residual potential and photosensitivity of the photoreceptors of Example 13 were suppressed after 1000 cycles compared to those of the photoreceptors of Comparative Example 6. Accordingly, the single layered photoreceptor of the present invention had excellent stability in electrical properties.

As described above, the electrophotographic photoreceptor of the present invention has excellent electrical properties, such as low residual potentials and high sensitivities, and high image quality and their stabilities by using a silane compound represented by Formula 1 to improve dispersion of a metal oxide in an undercoat layer and combining a specific charge generating material and a charge transporting material. The electrophotographic imaging apparatus employing the electrophotographic photoreceptor of the present invention can stably provide high quality images after repeated long-term use or used in various environments such as in an environment of high temperatures and high humidity.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophotographic photoreceptor comprising an electrically conductive substrate, an undercoat layer and a photosensitive layer that are sequentially formed on the electrically conductive substrate,
wherein the undercoat layer comprises a silane compound represented by Formula 1, a metal oxide, and a binder resin: 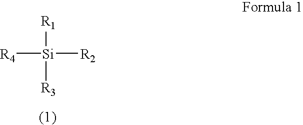
where R₁ to R₄ are each independently selected from the group consisting of a C₁-C₉ alkyl group, a C₁-C₉ alkoxy group, a phenyl group, and a phenoxy group.

2. The electrophotographic photoreceptor of claim 1, wherein the photosensitive layer is a laminated type comprising a charge generating layer having a charge generating material and a charge transporting layer having a charge transporting material.

3. The electrophotographic photoreceptor of claim 1, wherein the photosensitive layer is a single layered type comprising a charge generating material and a charge transporting material in a single layer.

4. The electrophotographic photoreceptor of claim 1, wherein the metal oxide is surface treated with the silane compound.

5. The electrophotographic photoreceptor of claim 1, wherein the amount of the silane compound is in the range of about 0.01 to 30 parts by weight based on 100 parts by weight of the metal oxide, and the amount of the binder resin is in the range of about 20 to 1000 parts by weight based on 100 parts by weight of the metal oxide.

6. The electrophotographic photoreceptor of claim 1, wherein the metal oxide comprises at least one compound selected from the group consisting of a tin oxide, an indium oxide, a zinc oxide, a titanium oxide, a silicon oxide, a zirconium oxide, and an aluminum oxide.

7. The electrophotographic photoreceptor of claim 1, wherein the thickness of the undercoat layer is in the range of about 0.2 to 20 μm.

8. The electrophotographic photoreceptor of claim 1, wherein the binder resin comprises at least one compound selected from the group consisting of a polyamide resin, a phenol resin, a melamine resin, an alkyd resin, polyurethane resin, an unsaturated polyester resin and an epoxy resin.

9. The electrophotographic photoreceptor of claim 1, wherein the charge generating material is a metal-free phthalocyanine-based compound represented by Formula 2, metal phthalocyanine-based compound represented by Formula 3, or a mixture thereof: 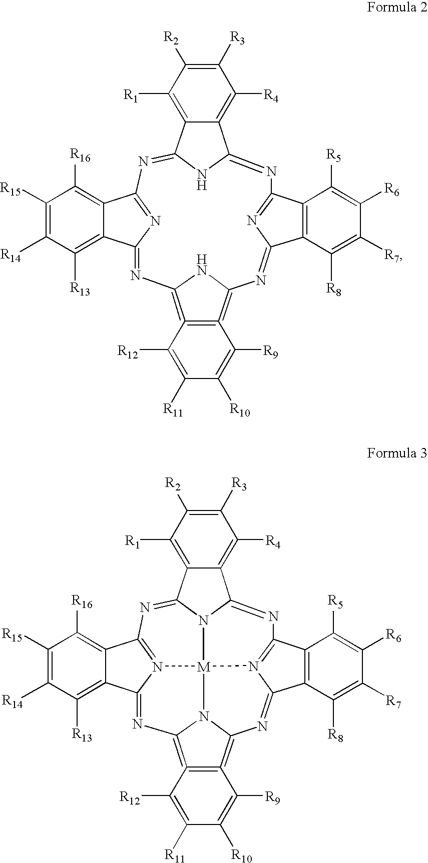
where R₁-R₁₆ are each independently selected from the group consisting of a hydrogen atom, a halogen atom, a nitro group, an alkyl group and an alkoxy group, and M is selected from the group consisting of copper, chloroaluminum, chloroindium, cholorogallium, cholorogermanium, oxyvanadyl, oxytitanyl, hydroxygermanium and hydroxygallium.

10. The electrophotographic photoreceptor of claim 1, further comprising a metal oxide layer between the electrically conductive substrate and the undercoat layer.

11. An electrophotographic imaging apparatus comprising an electrophotographic photoreceptor, a charging device for charging a photosensitive layer of the electrophotographic photoreceptor, a light exposing apparatus for forming an electrostatic latent image on a surface of the photosensitive layer of the electrophotographic photoreceptor, and a developing apparatus for developing the electrostatic latent image,
wherein the electrophotographic photoreceptor comprises an electrically conductive substrate, an undercoat layer and a photosensitive layer that are sequentially formed on the electrically conductive substrate, wherein the undercoat layer comprises a silane compound represented by Formula 1, a metal oxide, and a binder resin: 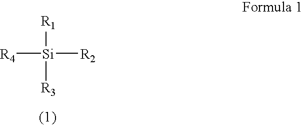
where R₁ to R₄ are each independently selected from the group consisting of a C₁-C₉ alkyl group, a C₁-C₉ alkoxy group, a phenyl group, and a phenoxy group.

12. The electrophotographic imaging apparatus of claim 11, wherein the photosensitive layer is a laminated type comprising a charge generating layer having a charge generating material and a charge transporting layer having a charge transporting material.

13. The electrophotographic imaging apparatus of claim 11, wherein the photosensitive layer is a single layered type comprising a charge generating material and a charge transporting material in a single layer.

14. The electrophotographic imaging apparatus of claim 11, wherein the metal oxide is surface treated with the silane compound of Formula 1.

15. The electrophotographic imaging apparatus of claim 11, wherein the amount of the silane compound is in the range of about 0.01 to 30 parts by weight based on 100 parts by weight of the metal oxide, and the amount of the binder resin is in the range of about 20 to 1000 parts by weight based on 100 parts by weight of the metal oxide.

16. The electrophotographic imaging apparatus of claim 11, wherein the metal oxide comprises at least one compound selected from the group consisting of a tin oxide, an indium oxide, a zinc oxide, a titanium oxide, a silicon oxide, a zirconium oxide, and an aluminum oxide.

17. The electrophotographic imaging apparatus of claim 11, wherein a thickness of the undercoat layer is in the range of about 0.2 to 20 μm.

18. The electrophotographic imaging apparatus of claim 11, wherein the binder resin of the undercoat layer comprises at least one compound selected from the group consisting of a polyamide resin, a phenol resin, a melamine resin, an alkyd resin, a polyurethane resin, an unsaturated polyester resin and an epoxy resin.

19. The electrophotographic imaging apparatus of claim 11, wherein the charge generating material is a metal-free phthalocyanine-based compound represented by Formula 2, a metal phthalocyanine-based compound represented by Formula 3, or mixtures thereof: 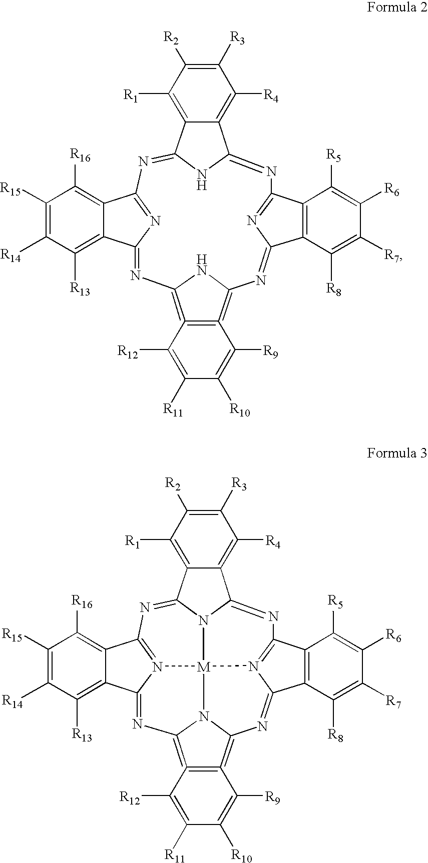
where R₁-R₁₆ are each independently selected from the group consisting of a hydrogen atom, a halogen atom, a nitro group, an alkyl group and an alkoxy group, and M is selected from the group consisting of copper, chloroaluminum, chloroindium, cholorogallium, cholorogermanium, oxyvanadyl, oxytitanyl, hydroxygermanium and hydroxygallium.

20. The electrophotographic imaging apparatus of claim 11, further comprising a metal oxide layer between the electrically conductive substrate and the undercoat layer.

21. A coating composition for forming an undercoat layer comprising:
about 100 parts by weight of a metal oxide treated with a silane compound represented by Formula 1;
about 20 to 1000 parts by weight of a binder resin; and
about 500 to 3000 parts by weight of an alcohol solvent including at least one alcohol selected from the group consisting of methanol, ethanol, isopropanol, 1-propanol, and 1-butanol: 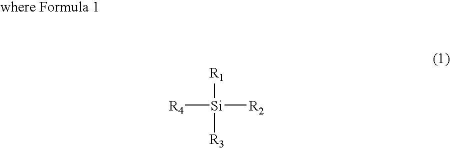
where R₁ to R₄ are each independently a C₁-C₉ alkyl group, a C₁-C₉ alkoxy group, a phenyl group, and a phenoxy group.

22. The coating composition of claim 21, wherein the surface of the metal oxide is surface treated with the silane compound of Formula 1.

23. The coating composition of claim 2 1, wherein the binder resin is selected from the group consisting of a polyamide resin, a phenol resin, a melamine resin, an alkyd resin, a polyurethane resin, an unsaturated polyester resin, an epoxy resin, and mixtures thereof.

24. The coating composition according of claim 21, wherein the silane compound is included in an amount of about 0.01 to 30 parts by weight based on 100 parts by weight of the metal oxide.

25. The coating composition of claim 21, wherein the metal oxide is selected from the group consisting of tin oxide, indium oxide, zinc oxide, titanium oxide, silicon oxide, zirconium oxide, aluminum oxide, and mixtures thereof.
